(19) United States
(12) Patent Application Publication
(10) Pub. No.: US 2013/0304629 A1
(43) Pub. Date: Nov. 14, 2013

(54) SELF FULLFILLED ONLINE FINANCIAL INSTRUMENT

(71) Applicant: MARK J. ATTAWAY, Yorba Linda, CA (US)

(72) Inventor: MARK J. ATTAWAY, Yorba Linda, CA (US)

(21) Appl. No.: 13/669,361

(22) Filed: Nov. 5, 2012

Related U.S. Application Data
(60) Provisional application No. 61/555,457, filed on Nov. 3, 2011.

(51) Int. Cl. G06Q 40/02

(52) U.S. Cl. CPC G06Q 40/025
USPC 705/38

(57) ABSTRACT

The system provides a method and apparatus for self fulfillment of financial instruments via an online system. The consumer is able to initiate, apply for, and complete a lending transaction completely online with minimal or no offline interaction with financial institutions. An advantage of the system is that it allows a consumer to receive information and offers from one to many lenders online and self-fulfill a loan or other financial instrument online without the need to interact with a traditional loan officer. The systems includes a shopping tool to help a consumer identify and make their own decision in selecting a loan that best fits their needs including an easy to complete online loan application, a rate locking feature that allows a consumer to lock and/or re-price their loan quickly, and an eSigning capability to simplify the signing process.

This patent application claims priority to U.S. Provisional Patent Application Ser. No. 61/555,457 filed on Nov. 3, 2011 which is incorporated by reference herein in its entirety.

### BACKGROUND OF THE SYSTEM

The ability of consumers to acquire financial instruments is currently limited to direct interactions with financial institutions. For example, if a consumer wishes to obtain a mortgage loan, the consumer must interact directly with a bank, savings and loan, loan broker, and the like. There have been some attempts to provide an online solution for consumers to obtain mortgage loans. However, these systems, such as www.lendingtree.com, www.greenlightloans, www.eloan.com, www.quickenloans.com, http://www.closeyourownloan.com, and the like, do not allow complete self-fulfillment of the lending process entirely online. Instead, these systems are only partial efforts that allow shopping for loans among a plurality of lenders. The consumer must still interact directly, and off-line with a lending financial institution.

### SUMMARY

The system provides a method and apparatus for self fulfillment of financial instruments via an online system. The consumer is able to initiate, apply for, and complete a lending transaction completely online without offline interaction with financial institutions. An advantage of the system is that it allows a consumer to receive information and offers from one to many lenders online and self-fulfill a loan or other financial instrument online without the need to interact with a traditional loan officer. The systems includes a shopping tool to help a consumer identify and make their own decision in selecting a loan that best fits their needs including an easy to complete online loan application, a rate locking feature that allows a consumer to lock and/or re-price their loan quickly, a powerful document upload feature, an alert system to keep the consumer current of any change in their loan status, product and pricing, an easy appointment scheduler to order and set appointments for appraisal and other services, signing of initial and final documents, etc., an eSigning capability to simplify the signing process for both the lender and the consumer, an online vault for eStorage of all applicable data and documents, and easy access to current topics affecting the mortgage and real estate markets.

For the lender, the system includes a lending technology platform, with a number of functions. These functions include a workflow engine to define and manage business orchestrations, an integration layer for easy access to electronic settlement and loan fulfilment services, security features that protect data and authenticate users, business intelligence tools that provide for powerful views of loan data and drives transparency, support for new investor loan quality and loan purchase data standards as part of loan underwriting and loan delivery, automation of processing and underwriting by using XML data structures to electronically process traditionally manual processes, delivery of MISMO compliant data to create eMortgage assets and electronic audit trail of all online processes stored for life of loan.

### BRIEF DESCRIPTION OF THE DRAWINGS

FIG. 1 is flow diagram illustrating the operation of one embodiment of the system.

FIG. 2 is a flow diagram illustrating an embodiment of the system for lenders.

FIG. 3 is a block diagram of an embodiment of the system.

FIGS. 4A-4C illustrate a flow diagram of an embodiment of a consumer mortgage self-fulfilment process of the system.

FIG. 5 is a flow diagram illustrating borrower incentive flow in one embodiment of the system.

FIG. 6 illustrates an example of loan options and rates.

FIG. 7 is an example computer embodiment of the system.

FIG. 8 is a flow diagram illustrating an embodiment of an underwriting tool of the system.

### DETAILED DESCRIPTION OF THE SYSTEM

FIG. 1 is a flow diagram illustrating the operation of the system from a consumer standpoint in one embodiment. At step 101 the consumer can perform a loan shopping function using the system. The system recommends the best loan for the consumer using one of the common selection strategies: lowest interest rate, lowest initial cost, or lowest effective rate. This step also allows the consumer to compare rates and terms from a plurality of lenders and to select a loan product that matches their particular needs. The system includes a number of tools to enable the consumer to compare loans effectively, including payment calculators, rate histories, reviews of other borrowers (e.g. how those other borrowers rated their experience with the loan provider, etc)., descriptions of the loan process, and the like. The system also selects one or more loans for the consumer based on parameters provided to the system by the consumer. The system provides a comparative breakdown of the plurality of loans to show how the loans compare to parameters.

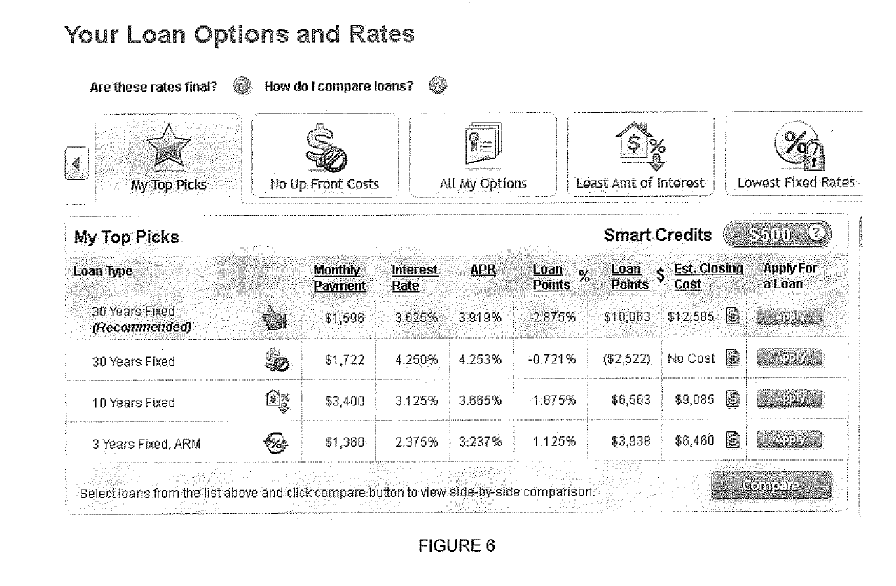

In one embodiment, the system presents a plurality of loan options in a standardized format with a plurality of metrics that describe each loan product, including term, fixed or variable, estimated monthly payment, interest rate, APR, points (if any), estimated closing costs (if any), and the like. The system may include a filtering operation that allows the consumer to eliminate loans that are not of interest, such as those with undesired terms, closing costs, and the like. The consumer may sort the presentation of the loans to focus on the metrics that are most important to the consumer, such as lowest to highest interest rate, lowest to highest monthly payments, and the like. FIG. 6 illustrates an example of loan options and rates where a credit is offered for selecting a particular loan option.

At step 102, the consumer completes an online loan application. In one embodiment of the system, a single loan application is completed that may be used or adopted by all participating lenders so that if the consumer decides to later change lenders and/or loan products, the application will be re-usable. The system includes an application engine that monitors the application and may require certain fields to be updated depending on the passage of time or other factors.

At step 103 the consumer is presented with an opportunity to lock rates for a loan product. This step provides online what some lenders offer in face to face transactions. In some cases, the rate lock feature may have time or activity based conditions, but these are all made clear to, and agreed to by, the consumer. The systems tracks the current selected loan product prior to locking and provides trending and other important information that can be used to decide when to lock). Additionally, the locking features gives the consumer the ability to re-price or select another loan based on the current rate environment.

At step 104 the system provides document upload and management for the loan process. Built in underwriting guidelines for income verification and other relevant documents based on the loan application responses allow the borrower to easily and quickly provide necessary documentation to the lender. The system identifies required documents along with definitions and examples, to aid the consumer in selecting and uploading the appropriate documents including pay stubs, W2 forms, tax returns, etc.

Step 105 provides scheduling and alert services to the client. Some offline activities are required for a mortgage loan, such as home inspection, appraisal, and the like. The system provides reminders and alerts the consumer about upcoming activities and deadlines so that the consumer can move forward in the loan process. The alert system is also used to ensure that the transaction continues to move at the quickest pace it can. Instead of relying on manual labor to track down missing docs, answers to questions, etc. the system continues to push the consumer for the necessary information.

Step 106 provides e-signature and eAcceptance capabilities as necessary for self-fulfilment of the loan online. Step 107 provides an online vault for all related documents. These documents are viewable at any time by the consumer via a web connection. In some cases, certain documents may be re-used in whole or in part for subsequent loan transactions, refinancing, and the like.

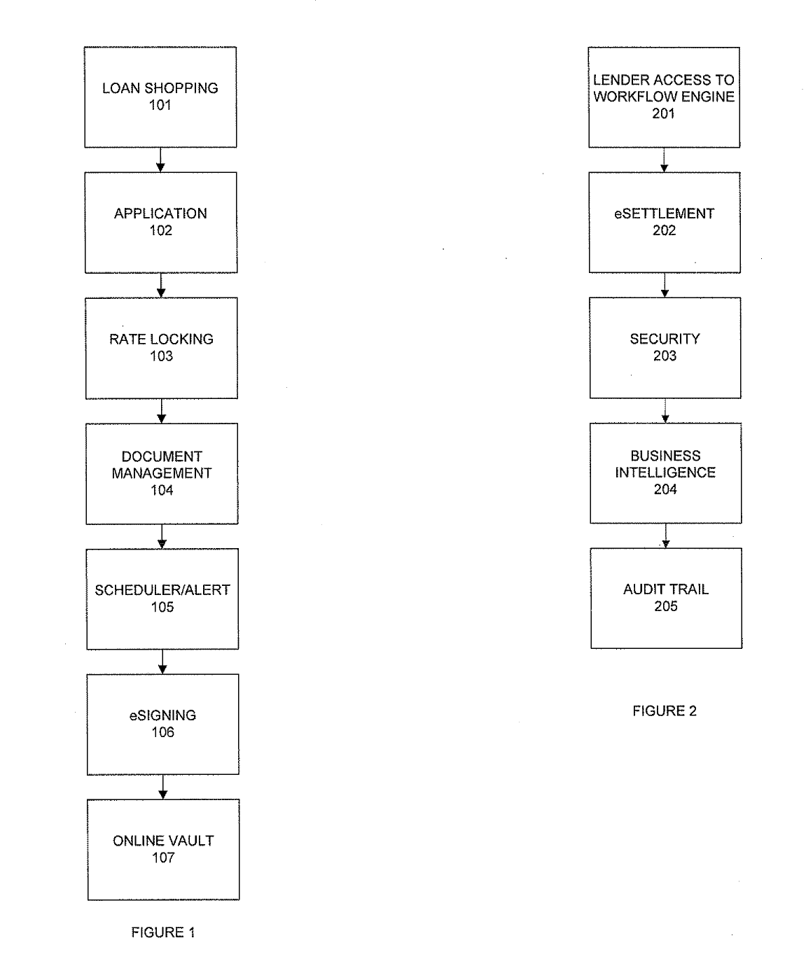

FIG. 2 is a flow diagram illustrating lender services in one embodiment of the system. At step 201 lenders access a workflow engine to define and manage business orchestrations (The system also has a UI to set up and manage workflow queues). At step 202 the system provides an integration layer for easy access to electronic settlement and loan fulfillment services. Step 203 provides security features that protects data and authenticates users. Step 204 provides business intelligence tools that provide for powerful views of loan data and drives transparency. Step 205 provides an audit trail of all online processes stored for at least the life of a loan.

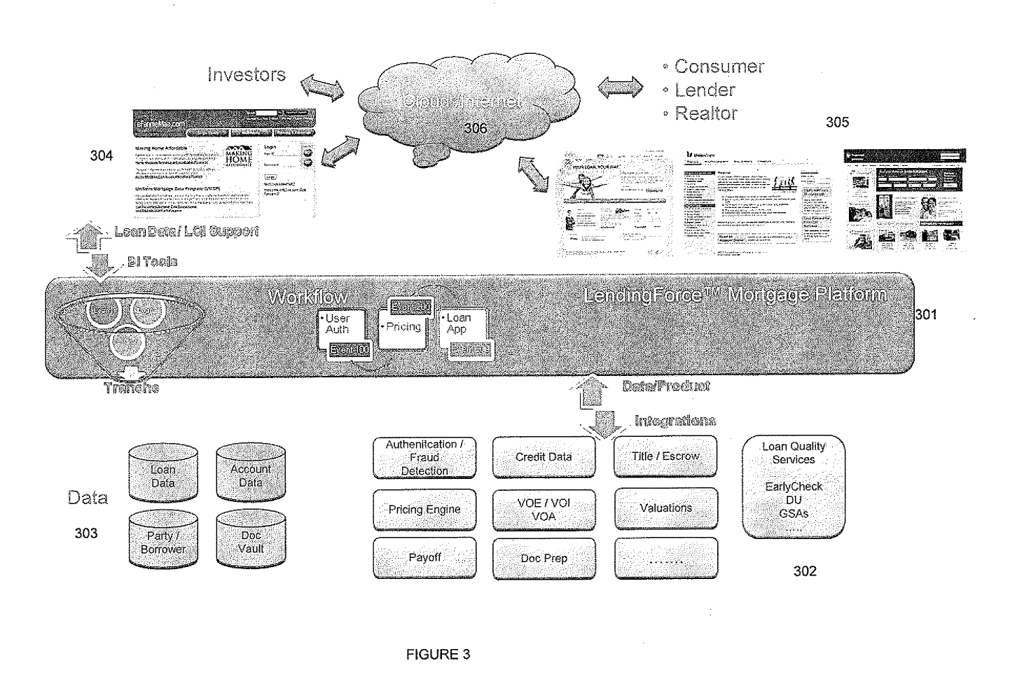

FIG. 3 is a block diagram of one embodiment of the system. The blocks of FIG. 3 may be implemented in hardware, software, or some combination of hardware and software. The system utilizes a workflow manager 301 to interact between loan operations 302 and data 303 on one side, and investors 304 and consumers/lenders/realtors 305 on the other side. Investors, consumers, lenders, and realtors interact with each other through a network such as interne 306.

The loan operations 302 includes a plurality of modules or engines to handle different aspects of the transactions. These modules include authentication/fraud detection to provide security to both the lenders and the consumers, to identify attempted fraud and identity theft, and to provide authentication of legitimate consumers. A pricing engine is used to calculate payments, interest/principal breakdowns, amortization schedules, and closing fees for the plurality of loans offered via the system. The consumer can use this module to more nearly define an “apples to apples” comparison of different loan offers. The payoff module is one of the functions of settlement (paying off existing mortgage(s), liens, etc.). Alternatively, the system can track the status of payoffs.

Credit data module gathers credit information for a consumer via one or more credit reporting agencies. This service can provide credit information for a fee or can accept credit information from a consumer engaged account as necessary. A verification module performs verification of employment (VOE), verification of income (VOI), and verification of address (VOA). A Document Prep module helps generate a checklist of required documents and tracks receipt, authentication, and acceptance of submitted documents in the system.

A title/escrow module provides the functions online of a typical offline title escrow company. A valuations module receives appraisal information and determines if loan requirements are being met by the submitted appraisal(s). A loan quality services module will take advantage of the data available to improve the reliability of loan quality assessments, providing confidence for loan re-purchasers. In one embodiment, the system does not perform the functions of a title, escrow or appraisal company but requests products be provided electronically. When received the system ensures items are managed and cleared whether manually or electronically.

The data storage 303 provides online vaults for loan data, account data, consumer/borrower data, and loan related documents. The system includes audit trail capabilities to provide confidence and trust in the stored data. The system encrypts data for security.

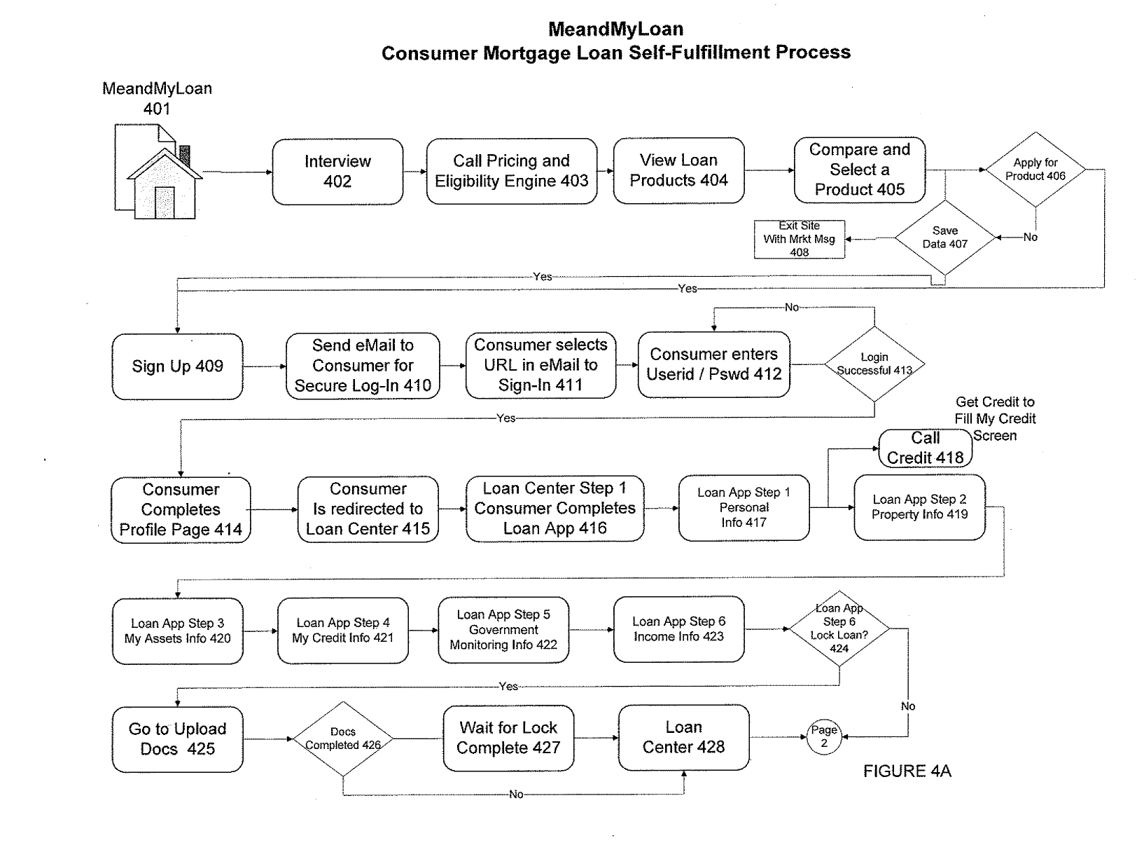

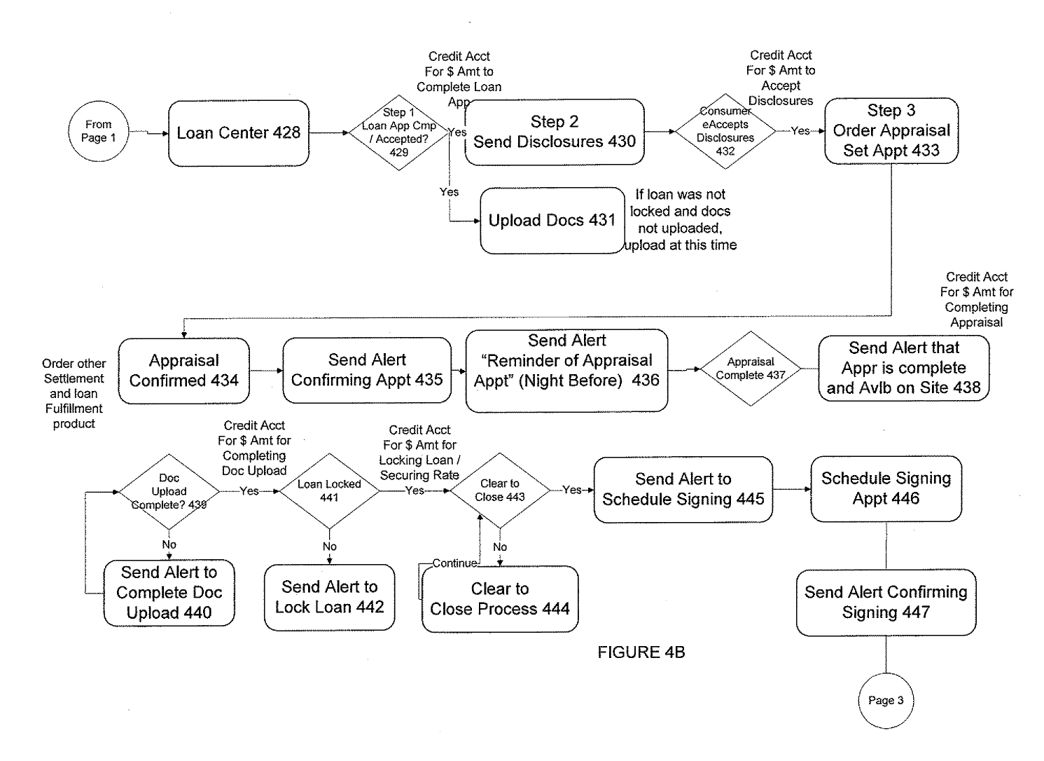

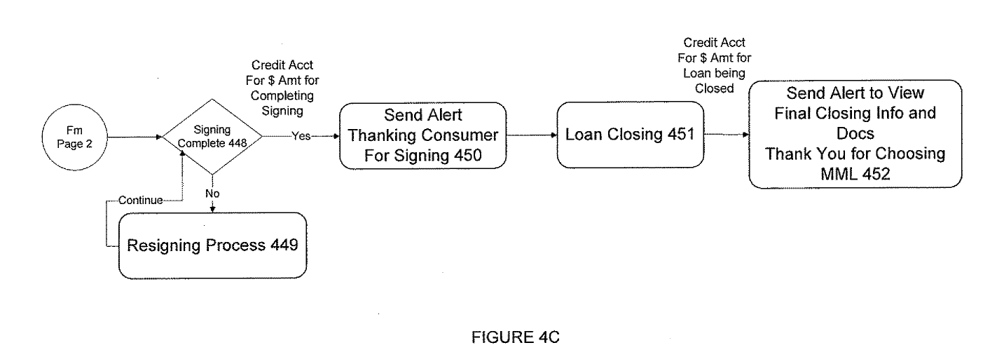

FIGS. 4A, 4B, and 4C illustrate one embodiment of the operation of the system during a loan process. At step 401 the consumer enters into the system, typically via a web browser to an online site. The system initiates an interview at step 402 with the consumer to determine the consumers lending needs and desires. At step 403 the system calls the pricing and eligibility engines to determine if the consumer qualifies for any of the offered loans and provides one or more loan products at step 404. The offered product(s) at step 404 represent the loans for which the consumer might qualify given the answers to the questions in the initial online interview.

At step 405 the consumer can compare the offered loan products using various parameters and can then select one of the loan products. Based on the loan product selected, the system implements underwriting tools (described below) to customize the remaining steps for the consumer based on the product selected.

At decision block 406 it is determined if the user is going to apply for the product using the system. If not, the system offers to save the data parameters at decision block 407 in case the consumer wishes to continue at a later time. If not, the system exits at step 408, perhaps with a marketing message to the user to encourage another attempt in the future or to suggest other unrelated products.

If the consumer wishes to continue at blocks 407 or 406, the system moves to step 409 to initiate a sign up process and make the consumer a registered user of the system. The system sends a secure email to the email address offered by the consumer during the interview step 402. This email allows the consumer to log-in to the system via the link in the email at step 411. On initial signup, the consumer selects a user ID and password at step 412. At decision block 413 it is determined if log in was successful. If not, the system returns to step 412. If so, the system moves to step 414. Once the consumer has created an account, the consumer can re-enter the system at step 412 in the future.

At step 414 the consumer completes a profile page which asks for more detailed information than was initially provided and then the system moves to the loan center at step 415. (Note that upon subsequent log-ins, the consumer does not need to complete the profile at step 414 unless there are incomplete items, modifications, or updates).

At step 416 the consumer completes a loan application. As noted above, this application may be a universal application that will be used by all participating lenders. However, in some embodiments, the application may be specific to the requested loan product. The consumer may save the loan application in progress and leave the system. Upon re-entry, the consumer can access the saved application and complete it at their own pace.

At step 417 the consumer enters personal information related to the loan application process. At step 418 the systems retrieves credit information about the consumer for one or more credit reporting agencies. This may be accomplished via an authorization executed by the consumer. At step 419 the system proceeds to obtain property information about the property for which the loan is requested.

At step 420 the system obtains consumer asset information and at step 421 credit information from step 418 is provided at the appropriate location in the application. This may be accomplished by normalizing the credit reporting data to match with the loan application format. The system can have a normalizing algorithm for each of the credit reporting agencies.

Step 422 queries government monitoring databases for information about the consumer. At step 423 the consumer enters income information. At decision block 424 the consumer is given the opportunity to request to rate lock the loan. If not, the system proceeds to FIG. 4B. If so, the system proceeds to step 425 where the consumer is prompted to upload required documents related to the loan application, including tax returns, pay stubs, proof of employment, and the like. At step 426 it is determined if all necessary documents have been uploaded. If so, the system waits for rate lock to complete at step 427 and proceeds to step 428. After step 428, the system proceeds to FIG. 4B.

At step 429 it is determined if the loan application was completed/accepted. If so, the system sends disclosures at step 430. If the consumer had not asked for loan lock at step 424, then required documents are uploaded now at step 431. At decision block 432 it is determined if the consumer eAccepts the disclosures. (The system in one embodiment has a code to prove the consumers were able to view the eDisclosures, this code will be keyed into an “Intent to Proceed” question and the Appraisal can be ordered and money for the Appraisal or other services collected. The consumer will use a code to eAccept the consnt to transact online with is completed prior to accessing the loan center for each transaction in one embodiment. The consumer may use a code to eSign all pages after review or use a “click and sign” operation to eSign each signature page). If so, the system moves to step 433 and an appraisal is ordered and the date of the appraisal is set.

At step 434 the appraisal is confirmed and scheduled. At step 435 the system sends an alert to the consumer confirming the appointment for the appraisal of the desired property. At step 436 the “night before” reminder of the appraisal is sent. At decision block 437 it is determined if the appraisal has been completed. If so, an alert is sent at step 438 that the appraisal is complete and is available on the site.

At step 439 it is determined if the document upload is completed. If not, the consumer is sent an alert at step 440 to complete the document upload. At step 441 it is determined if the loan is locked. If not, an alert is sent to lock the loan at step 442. At step 443 it is determined if the loan is cleared to close. If not, the system moves to step 444 and determines what is needed to close the process. At step 445 an alert is sent to the consumer to schedule a signing to close the loan. At step 446 a signing appointment is scheduled and a reminder is sent at step 447. The system then proceeds to FIG. 4C.

At decision block 448 it is determined if the signing was complete. If not, the system schedules a re-signing process at step 449. If so, the system proceeds to step 450 and send an alert to the consumer confirming the completion of signing. At step 451 the loan closes and at step 452 the system sends final closing information at step 452.

One embodiment of the system is described in Appendices A and B attached hereto.

Borrower's Incentives

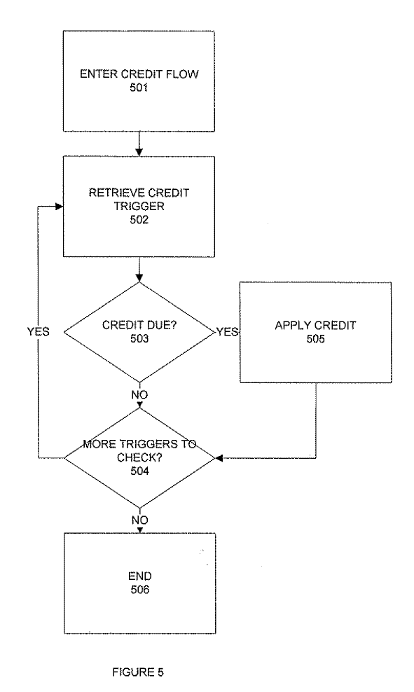

In one embodiment, the borrower is incentivized to participate in the process in return for credits for completing different aspects of the application. FIG. 5 is a flow diagram illustrating credit incentives in one embodiment of the system. It should be understood that this is an example only, and other triggers, amounts, and incentives can be used without departing from the scope and spirit of the system.

At step 501 the system enters the completion credit flow. At step 502 the system retrieves a credit trigger. This means reviewing one of the events whose completion would entitle the consumer to a credit. In one embodiment, these events can include, but not be limited to, the following events and credit amounts. Application completion ($125); Review GFE and Loan Disclosures ($100); Order appraisal ($100); Upload documents ($75); Rate lock ($50); and Schedule signing ($50).

At decision block 503 it is determined if a credit is due to the consumer for the retrieved event. If so, the system applies the credit at step 505. After step 505, or if no credit is due at step 503, the system proceeds to step 504 and determines if there are more triggers to check. If so, the system returns to step 502 and retrieves the next trigger. If not, the system ends at step 506.

Underwriting Tools

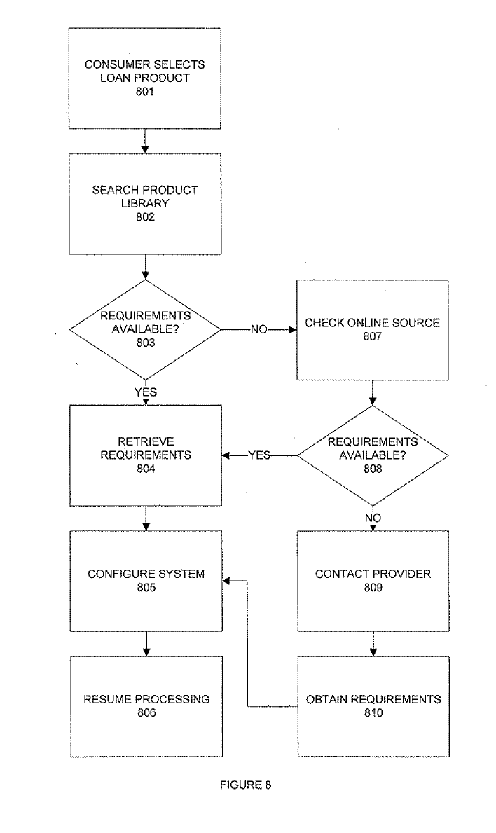

FIG. 8 is a flow diagram illustrating the application of underwriting tools in one embodiment of the system. When a consumer selects a loan product, the system applies the underwriting tools to configure the loan process appropriately for the product selected. At step 801 the consumer selects the loan product for which the consumer wishes to apply. At step 802 the system searches its database. The system maintains a database of the underwriting requirements for a plurality of loan products. In one embodiment, the system allows the loan provider to access the system to modify and update requirements accordingly.

At decision block 803 it is determined if the loan requirements for the selected product are available. If so, the system proceeds to step 804 and retrieves the requirements. At step 805 the system is reconfigured so that the appropriate requirements are met for processing the loan. This may include modifying the consumer documents to be provided, setting timing deadlines, and other metrics that are associated with the loan product. At step 806 the system resumes the loan application process in the reconfigured state.

If the requirements are not available at decision block 803, the system proceeds to step 807 and checks online with the provider to determine if the requirements can be accessed automatically. At decision block 808 it is determined if the requirements are available. If so, the system proceeds to step 804. If not, the system contacts the loan product provider at step 809 and obtains the requirements from them at step 810. The system then proceeds to step 805.

Embodiment of Computer Execution Environment (Hardware)

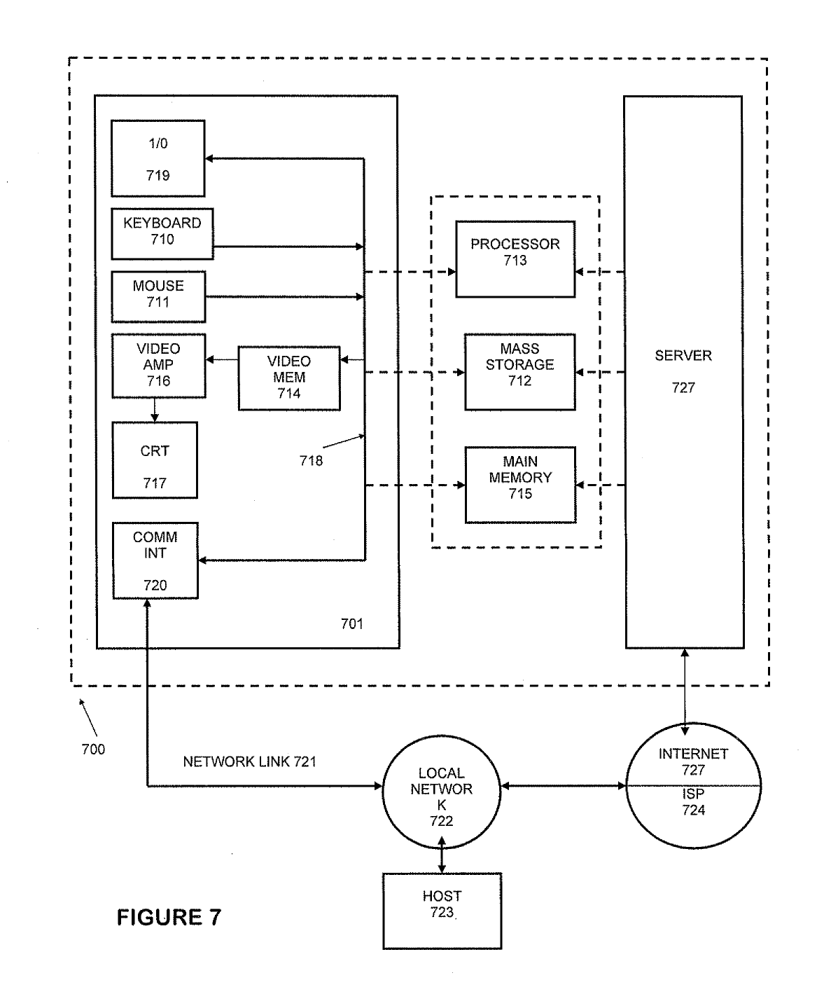

An embodiment of the system can be implemented as computer software in the form of computer readable program code executed in a general purpose computing environment such as environment 700 illustrated in FIG. 7, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU 713. Other suitable input devices may be used in addition to, or in place of, the mouse 711 and keyboard 710. I/O (input/output) unit 719 coupled to bi-directional system bus 718 represents such I/O elements as a printer, AIV (audio/video) I/O, etc.

Computer 701 may be a laptop, desktop, tablet, smart-phone, or other processing device and may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 727 Local network 722 and Internet 727 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 727 or processor 713 may have its computational power distributed between computer 701 and server 727. Server 727 symbolically is represented in FIG. 7 as one unit, but server 727 can also be distributed between multiple “tiers”. In one embodiment, server 727 comprises a middle and back tier where application logic executes in the middle tier and persistent data is obtained in the back tier. In the case where processor 713 resides wholly on server 727, the results of the computations performed by processor 713 are transmitted to computer 701 via Internet 727, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713.

As with processor 713, in various computing environments, main memory 715 and mass storage 712, can reside wholly on server 727 or computer 701, or they may be distributed between the two. Examples of systems where processor 713, main memory 715, and mass storage 712 are distributed between computer 701 and server 727 include thin-client computing architectures and other personal digital assistants, Internet ready cellular phones and other Internet computing devices, and in platform independent computing environments.

The mass storage 712 may include both fixed and removable media, such as magnetic, optical or magnetic optical storage systems or any other available mass storage technology. The mass storage may be implemented as a RAID array or any other suitable storage means. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a microprocessor such as manufactured by Intel, AMD, Sun, etc. However, any other suitable microprocessor or microcomputer may be utilized, including a cloud computing solution. Main memory 715 is comprised of dynamic random access memory (DRAM). Video memory 714 is a dual-ported video random access memory. One port of the video memory 714 is coupled to video amplifier 719. The video amplifier 719 is used to drive the cathode ray tube (CRT) raster monitor 717. Video amplifier 719 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 727 might transmit a requested code for an application program through Internet 727, ISP 724, local network 722 and communication interface 720. The received code maybe executed by processor 713 as it is received, and/or stored in mass storage 712, or other non-volatile storage for later execution. The storage may be local or cloud storage. In this manner, computer 700 may obtain application code in the form of a carrier wave. Alternatively, remote server computer 727 may execute applications using processor 713, and utilize mass storage 712, and/or video memory 715. The results of the execution at server 727 are then transmitted through Internet 727, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Thus, a self-fulfilled instrument process has been described.

What is claimed is:

1. A method of self-fulfillment of a financial instrument comprising:
in an online processing system;
selecting one of a plurality of loan products;
requesting data from a user to complete an application for the loan product;
providing the requested data;
determining if the requested data is complete;
approving the loan product to the user.

2. The method of claim 1 wherein the user accesses the system through a secure connection.

3. The method of claim 1 wherein the requested data is based on the loan product selected.

4. The method of claim 1 wherein the requested data includes physical documents to be uploaded to the system.

5. The method of claim 1 wherein the system uses XML data to automate the underwriting process by using XML from third party providers and from document images from the user converted to XML data.

6. The method of claim 1 wherein the system alerts the user for information required to complete the application.

7. The method of claim 1 further including the step of scheduling third party services through the system.

8. The method of claim 1 further including the granting of credits to the user based on completion of portions of the application.

9. The method of claim 1 further including the option of rate lock of the loan product.
